(19) United States
(12) Patent Application Publication
(10) Pub. No.: US 2016/0218837 A1
(43) Pub. Date: Jul. 28, 2016

(54) METHOD AND APPARATUS TO USE MORE TRANSMISSION OPPORTUNITIES IN A DISTRIBUTED NETWORK TOPOLOGY WITH LIMITED HARQ PROCESSES

(71) Applicant: ZTE Wistron Telecom AB, Kista (SE)

(72) Inventors: Patrick SVEDMAN, Kista (SE); Jan JOHANSSON, Kista (SE); Thorsten SCHIER, Kista (SE); Bojidar HADJISKI, Kista (SE); Aijun CAO, Kista (SE); Yonghong GAO, Kista (SE)

(21) Appl. No.: 14/844,975

(22) PCT Filed: Mar. 14, 2014
(86) PCT No.: PCT/US14/29188

§ 371 Date: Sep. 3, 2015

Related U.S. Application Data
(60) Provisional application No. 61/784,682, filed on Mar. 14, 2013.

(51) Int. Cl. H04L 1/18; H04W 72/12

(52) U.S. Cl. CPC H04L 1/1861; H04W 72/1284; H04W 72/1289; H04L 1/1812

(57) ABSTRACT

A method and system for transmitting data to user equipment (UE) is disclosed. In one embodiment, the system includes: a downlink transmitter configured to transmit a first data unit to the UE using a first transmission process assigned to the UE; an uplink receiver configured to receive a status signal indicating either a successful or unsuccessful reception of the first data unit by the UE; and a downlink scheduler, communicatively coupled to the downlink transmitter and uplink receiver, and configured to receive the status signal from the uplink receiver, wherein the downlink scheduler is further configured to schedule transmission of a second data unit to the UE and transmit a corresponding scheduling decision to the downlink transmitter prior to receiving the status signal, and wherein upon receiving the scheduling decision, the downlink transmitter transmits the second data unit to the UE using a second transmission process assigned to the UE.

### CROSS-REFERENCE TO RELATED APPLICATIONS

This application claims benefit of priority under 35 U.S.C. §119(e) to Provisional Application No. 61/784,682, titled “Method and Apparatus to Use More Transmission Opportunities in a Distributed Network Topology with HARQ Processes.” filed Mar. 14, 2013, which is incorporated by reference herein in its entirety.

### FIELD OF THE INVENTION

The present invention relates generally to the field of cellular communications, and more particularly to methods and apparatuses for using more transmission opportunities in a distributed network topology with backhaul delays among network components and Hybrid Automatic Repeat reQuest (HARQ) processes.

### BACKGROUND OF THE INVENTION

In order to improve the performance of digital communication systems, retransmission protocols are often used. The digital information is often grouped in blocks or packets. The successful reception of a block of data can be detected by the receiver by using for example a cyclic redundancy check (CRC). The unsuccessful reception of a block can in some situations or systems be ignored by the receiver. In other situations or systems, the receiver may inform the transmitter of the result of the reception of a block, using for example an ACK/NACK, where an ACK (ACKnowledgement) indicates that the block was successfully received and a NACK (Negative ACKnowledgement) indicates that the block was not successfully received. For example, the LTE RLC (Radio Link Control) provides three different data transmission modes: transparent mode (TM), unacknowledged mode (UM) and acknowledged mode (AM). Only RLC blocks transmitted in AM can be acknowledged by the receiving RLC and retransmitted by the transmitting RLC. For the other two modes, an incorrectly received RLC block is simply discarded.

Many digital communication systems follow a layered model, for example the OSI model or the TCP/IP model. In a layered system, there may be retransmission protocols in multiple layers. Data is to be transmitted from the “Transmitter” to the “Receiver.” Note that also a reverse link between the “Receiver” and the “Transmitter” is needed, for example to feedback ACK/NACKs. A layered system includes for example layer 1 (L1), layer 2 (L2) and layer 3 (L3). Both L2 and L3 use retransmission protocols. The L2 receiver responds to the L2 transmitter with an ACK/NACK at the successful/unsuccessful reception of an L2 block. Similarly, the L3 receiver responds to the L3 transmitter with an ACK/NACK at the successful/unsuccessful reception of an L3 block. Note that there is not necessarily direct correspondence between an L2 block and an L3 block, i.e. an L2 block can carry multiple L3 blocks or only a part of one L3 block.

This disclosure applies to examples in which the lowest level retransmission protocol (e.g. the L2 retransmission protocol) uses Hybrid Automatic Repeat reQuest (HARQ) with soft combining as well as to other examples. For simplicity and without loss of generality, the disclosure is described in conjunction with an example in which L2 uses a HARQ protocol with soft combining. For simplicity and without loss of generality, the disclosure is described in conjunction with an example in which the next layer above L2 that uses a retransmission protocol is L3. This choice matches the LTE retransmission protocol, where L2 (MAC) uses HARQ with soft combining and L3 (RLC) uses retransmissions for data in AM.

An example of L2 HARQ with soft combining is described below:
The receiver L2 responds with an ACK/NACK a known time delay after the transmission of the L2 block.
   a. In the LTE FDD downlink for example, the UE should respond with an ACK/NACK (on PUCCH or on PUSCH) 4 sub-frames after the transmission of the corresponding transport block.
   b. In the LTE FDD uplink for example, the eNodeB should respond with an ACK/NACK (explicitly on PHICH or implicitly on PDCCH) 4 sub-frames after the transmission of the corresponding L2 transport block.
   c. In LTE TDD for example, the ACK/NACK time delay after the transmission of the corresponding transport block depends on the TDD uplink/downlink configuration. Since the configuration is known, the time delay can also be deduced.
If the receiver L2 responds with a NACK, i.e. the L2 block was incorrectly received, then the receiver keeps the soft bits of the incorrectly received block in its soft bit memory.
   d. The stored soft bits can be softly combined with a subsequent retransmission to improve the probability of a successful reception.
   e. If the L2 block was correctly received, there is no need to keep the corresponding soft bits in the memory.
Multiple parallel HARQ processes are used.
   f. A transmission of an L2 block is connected to one HARQ process.
   g. Retransmissions of an L2 block needs to be done using the same HARQ process as the first transmission of the block.
   h. The receiver keeps a soft bit memory buffer for each HARQ process.
   i. A retransmission on a HARQ process is softly combined in the receiver with the soft bits in the memory buffer for the same HARQ process.
   j. The different HARQ processes can be distinguished through different HARQ process indices.
The L2 transmitter may transmit a new L2 block on a HARQ process when
   k. it knows/recognizes that the previous L2 block of the same HARQ process was received correctly, or
   l. the maximum number of retransmissions was reached of the previous L2 block of the same HARQ process.
      The L2 receiver may let the soft bits of a new L2 block overwrite the soft bits of the previous L2 block of the same HARQ process.

In some example systems, multiple blocks (e.g. L2 blocks) can be transmitted from a transmitter to a receiver at the same time, with the receiver responding with multiple corresponding ACK/NACKs, or a combination thereof In one example, these multiple blocks and corresponding multiple ACK/NACKs (or a combination thereof) are connected to the same HARQ process, and the individual blocks could be seen as connected to sub-processes of the HARQ process. In another example, these multiple blocks and corresponding multiple ACK/NACKs (or a combination thereof) are connected to different HARQ processes. Both these cases are covered by this disclosure. However, for simplicity and readability, the case with a single block per HARQ process and time is described herein.

In some example systems, such as some TD-LTE downlink configurations with bundling, the ACK/NACKs of multiple HARQ processes are bundled into a single ACK/NACK. These cases are also covered by this disclosure, since the receiver of a bundled ACK/NACK can draw some conclusions of the ACK/NACKs of the individual HARQ processes from the bundled ACK/NACK, and thereby request or choose retransmission or not.

A finite amount of time is required between successive transmit-ACK/NACK-transmit or retransmit cycles. During this time, a HARQ process is not used for another transmission, since this would risk overwriting the soft bits in the HARQ process memory buffer. Therefore, in order to enable the continuous transmission of data blocks, multiple HARQ processes are needed, that can run in parallel. In FDD LTE, for example, both the downlink and the uplink provides 8 HARQ processes per UE.

Base stations and UEs each include at least one transmitter and at least one receiver. Additionally, base stations include a scheduler for scheduling downlink transmissions. Currently, the downlink transmitter, uplink receiver and downlink scheduler are all located in the base station. The downlink receiver and the uplink transmitter are located in the UE. In the current base station architecture, the downlink transmitter, uplink receiver and downlink scheduler are all co-located in one place. However, there is a trend toward new network topologies, such as distributed network topologies, in which the downlink transmitter may be located in a node in one physical location, the uplink (ACK/NACK) receiver may be located in another node in another physical location, and the scheduler may be located in a third node in a third physical location, with these nodes being connected with non-ideal backhaul. Since the nodes are not co-located, there can be a significant backhaul delay between the reception of an ACK/NACK in the uplink receiver and the time the ACK/NACK can be used in the downlink scheduling. Similarly, there can be a significant backhaul delay between the downlink scheduling and the actual downlink transmission based on the scheduling. Thus, the downlink transmitter may not be ready to transmit the next block or retransmit the prior block when in the transmission interval allocated to the process. Instead, the downlink transmitter will have to wait until a subsequent transmission interval before performing the transmission or retransmission, resulting in a reduction of data rate from the downlink transmitter to the user equipment.

### SUMMARY OF THE INVENTION

The invention addresses the above and other needs by providing a method and system for transmitting data to a UE even though the status of a previous transmission to the UE is unknown, thereby improving the data rate of transmission to the UE.

In one embodiment of the invention, a system for transmitting data to user equipment (UE), includes: a downlink transmitter configured to transmit a first data unit to the UE using a first transmission process assigned to the UE; an uplink receiver configured to receive a status signal indicating either a successful or unsuccessful reception of the first data unit by the UE; and a downlink scheduler, communicatively coupled to the downlink transmitter and uplink receiver, and configured to receive the status signal from the uplink receiver, wherein the downlink scheduler is further configured to schedule transmission of a second data unit to the UE and transmit a corresponding scheduling decision to the downlink transmitter prior to receiving the status signal, and wherein upon receiving the scheduling decision, the downlink transmitter transmits the second data unit to the UE using a second transmission process assigned to the UE. In a further embodiment, a method for transmitting data to user equipment (UE), includes: transmitting a first data unit to the UE using a first transmission process assigned to the UE; awaiting receipt of a status signal indicating either a successful or unsuccessful reception of the first data unit by the UE; prior to receiving the status signal, scheduling transmission of a second data unit to the UE; and transmitting the second data unit to the UE using a second transmission process assigned to the UE.

In yet another embodiment, the invention provides a computer-readable medium storing computer program code that when executed perform a method for transmitting data to user equipment (UE), the method including: transmitting a first data unit to the UE using a first transmission process assigned to the UE; awaiting receipt of a status signal indicating either a successful or unsuccessful reception of the first data unit by the UE; prior to receiving the status signal, scheduling transmission of a second data unit to the UE; and transmitting the second data unit to the UE using a second transmission process assigned to the UE.

Further features and advantages of the present invention, as well as the structure and operation of various embodiments of the present invention, are described in detail below with reference to the accompanying drawings.

### BRIEF DESCRIPTION OF THE DRAWINGS

The present invention, in accordance with one or more various embodiments, is described in detail with reference to the following Figures. The drawings are provided for purposes of illustration only and merely depict exemplary embodiments of the invention. These drawings are provided to facilitate the reader's understanding of the invention and should not be considered limiting of the breadth, scope, or applicability of the invention. It should be noted that for clarity and ease of illustration these drawings are not necessarily made to scale.

FIG. 1 illustrates an embodiment of a distributed topology cellular communications network.

FIG. 2 is signaling and processing diagram of an embodiment of a HARQ process, in a cellular network with minimal backhaul delays.

FIG. 3 is signaling and processing diagram of an embodiment of a HARQ process, in a distributed network topology with substantial backhaul delays.

FIG. 4 is a flowchart of an embodiment of scheduling processing according to the present disclosure.

FIG. 5 is a flowchart of an embodiment of response processing according to the present disclosure.

### DETAILED DESCRIPTION OF EXEMPLARY EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

In the following description of exemplary embodiments, reference is made to the accompanying drawings which form a part hereof, and in which it is shown by way of illustration of specific embodiments in which the invention may be practiced. It is to be understood that other embodiments may be utilized and structural changes may be made without departing from the scope of the preferred embodiments of the invention.

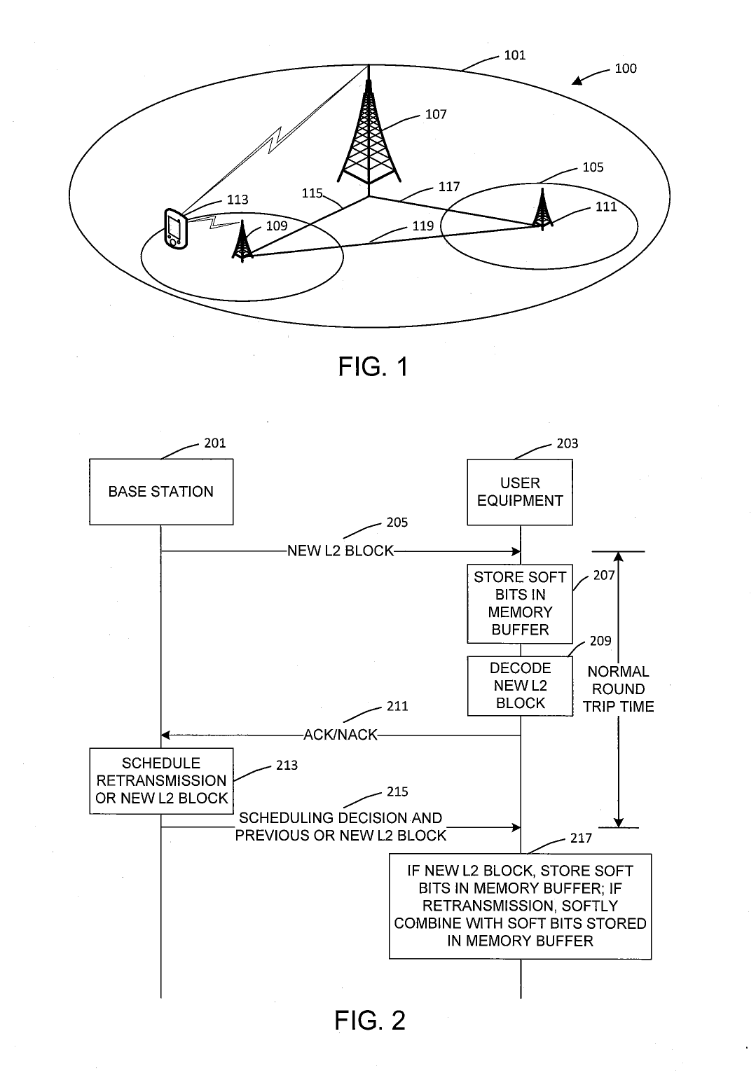

Referring now to the drawings, and first to FIG. 1, an embodiment of a distributed topology cellular telecommunications network is designated generally by the numeral 100. Distributed topology network 100 comprises a large cell 101 and at least two small cells 103 and 105. Large cell 101 includes a large cell base station 107. Small cells 103 and 105 each include a small cell base station 109 and 111, respectively.

Cells 101, 103 and 105 comprise nodes of distributed topology network 100. Base stations 107-111 are interconnected by backhauls 115-119. In some embodiments, base stations 107 and 109 are connected to each other by backhaul 115 and base stations 107 and 111 are connected by backhaul 117. A mobile terminal or user equipment (UE) 113 is located in cells 101 and 103.

Each base station 107, 109 and 111 may include a downlink transmitter, a downlink scheduler and an uplink receiver (not shown in FIG. 1). According to embodiments of the present disclosure, the downlink (DL) transmitter, DL scheduler and uplink (UL) receiver functions for the session with UE 113 are distributed across distributed topology network 100. Specifically, base station 107 provides the DL transmitter, base station 109 provides the UL receiver, and base station 111 provides the DL scheduler. Since base stations 109 and 111 are not co-located, there is can be a significant backhaul delay between the reception from UE 113 of an ACK/NACK in the UL receiver of base station 107 and the time the ACK/NACK can be used in the DL scheduler of base station 111. Similarly, there can be a significant backhaul delay between the DL scheduling in base station 111 and the actual DL transmission from base station 107, based on the scheduling.

In some embodiments, the downlink transmitter may be located in multiple nodes in multiple physical locations, for example if coordinated multi-point (CoMP) with joint transmission is used. In one embodiment, these nodes or a subset thereof may be connected with a non-ideal backhaul. In some embodiments, the uplink receiver may be located in multiple nodes in multiple physical locations, for example if coordinated multi-point (CoMP) with joint reception is used. In one embodiment, these nodes or a subset thereof may be connected with a non-ideal backhaul. In some embodiments, the scheduler may be located in a multiple nodes in multiple physical locations. In one embodiment, these nodes or a subset thereof may be connected with a non-ideal backhaul. In some embodiments, for different UEs, different functions may be located in different nodes. For instance, the downlink to one UE may be transmitted from a different node than the downlink to another UE.

To understand the backhaul delay concept better, FIG. 2 illustrates the situation where the DL transmitter, DL scheduler and UL receiver are all co-located in the same base station 201. Base station 201 transmits to UE 203 a new L2 block, as indicated at 205. UE 203 stores soft bits in its memory buffer, as indicated at process block 207, and decodes the new L2 block, as indicated at process block 209. Depending on the result of the decoding step, UE 203 transmits back to base station 201 either an ACK response or a NACK response, as indicated at 211. The DL scheduler of base station 201 schedules either a retransmission of the prior L2 block or a new L2 block, based up whether it received an ACK or a NACK, as indicated at process block 213. The transmitter of base station 201 then transmits to UE 203 the scheduling decision and the previous or the new L2 block, as indicated at 215. The time elapsed between the transmission of the new L2 block, at 205, and the receipt of the previous or new L2 block, at 215, constitutes the normal round trip time, which in LTE is five to eight sub-frames. If UE 203 receives a new L2 block, UE 203 stores the new L2 block in its memory buffer; if UE 203 receives a retransmitted prior L2 block, UE 203 softly combines the retransmission with the soft bits stored in its memory buffer, all as indicated at process block 217.

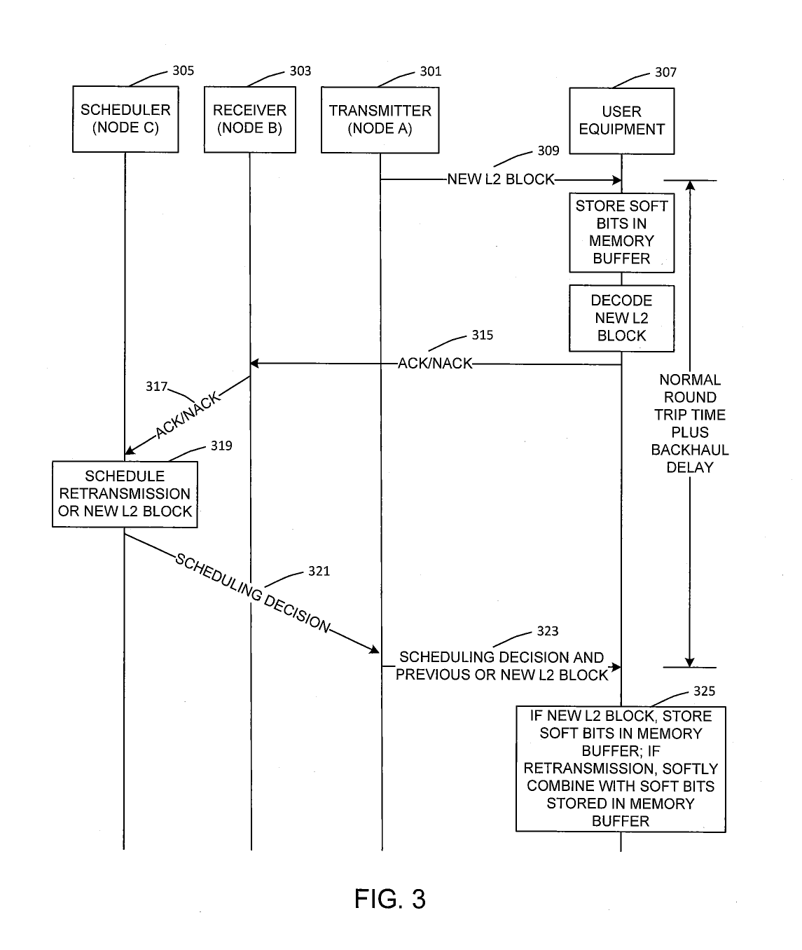

FIG. 3 illustrates the situation where a DL transmitter 301 is located at a first physical location (Node A), a UL receiver 303 is located at a second physical location (Node B), and a DL scheduler 305 is located at a third physical location (Node C). DL transmitter 301 transmits to UE 307 a new L2 block, as indicated at 309. UE 307 stores soft bits in its memory buffer, as indicated at process block 311, and decodes the new L2 block, as indicated at process block 313. Depending on the result of the decoding step, UE 307 transmits to UL receiver 303 either an ACK response or a NACK response, as indicated at 315. UL receiver 303 transmits the ACK or NACK to DL scheduler 305 over a low speed backhaul, as indicated at 317. DL scheduler 305 schedules either a retransmission of the prior L2 block or a new L2 block, based up whether it received an ACK or a NACK, as indicated at process block 319. DL scheduler 305 then transmits to DL transmitter 301 the scheduling decision over a low speed backhaul, as indicated at 321. DL transmitter 301 then transmits to UE 307 the scheduling decision and the previous or the new L2 block, as indicated at 323. The time elapsed between the transmission of the new L2 block, at 309, and the receipt of the previous or new L2 block, at 323, constitutes the normal round trip time plus the backhaul delay The actual amount of the backhaul may be as much as twenty sub-frames. If UE 307 receives a new L2 block, UE 307 stores the new L2 block in its memory buffer; if UE 307 receives a retransmitted prior L2 block, UE 307 softly combines the retransmission with the soft bits stored in its memory buffer, all as indicated at process block 325.

The backhaul delays that the distributed network topology introduces thus cause the HARQ process roundtrip time to increase, compared to when the network functions were co-located without significant internal delays. The increased HARQ process roundtrip time can result in a situation in which a single UE cannot be scheduled continuously, i.e. for each consecutive transmission opportunity, since the number of HARQ processes is fixed and limited. This reduces the maximum data rate of the UE. For example, consider the LTE downlink. In one embodiment, the distributed network topology is such that a retransmission on a HARQ process can occur at the earliest 20 sub-frames after the first transmission, due to backhaul delays between some of the distributed network functions. Then, following the regular DL HARQ procedure, the UE can be scheduled in only 8 of 20 sub-frames (40%), since there are 8 DL HARQ processes in LTE. Note that even though the considered UE cannot be scheduled continuously, another UE may be scheduled, since the HARQ processes are per UE. Hence, all time-frequency resources may be used anyway.

A HARQ process is considered available for scheduling, if the scheduler knows the result of the previous transmission, i.e. if it resulted in an ACK or in a NACK. If it was a NACK, a retransmission can be scheduled and if it was an ACK, a new L2 block of data can be scheduled for transmission without risking overwriting soft bits of a previous transmission that could be used for soft combining.

According to embodiments of the present disclosure, if there are no HARQ processes available for scheduling, then a new L2 block can be scheduled for transmission anyway, on a HARQ process that is not available. If possible, the scheduler selects an unavailable HARQ process for which the previous block carried L3 traffic that does not require the delivery of each L3 block (e.g. unacknowledged mode traffic in LTE RLC). The scheduled new data transmission advantageously avoids any risk of interfering with the decoding of the previous L2 block on the same HARQ process. For example, if the UE has already started to transmit the ACK/NACK, then it is clear that the decoding of the previous L2 block has already been finished.

Eventually, the DL transmitter will learn of the result of the previous L2 block on HARQ process. If the L2 block decoding result was an ACK, then it did not matter that the soft bits in the memory buffer were (or will be, if the transmission has not occurred yet) overwritten by the new transmission. On the other hand, if the L2 block decoding result was a NACK, then the soft bits of the unsuccessfully received L2 block were (or will be) overwritten by the new transmission. Therefore, a retransmission with soft combining is no longer possible. The unsuccessfully received L2 block is called a lost block. If the lost block carried traffic that requires delivery of each block (e.g. acknowledged mode traffic in LTE RLC), then the lost block is advantageously retransmitted. The lost block may be transmitted again as one or several new L2 blocks, without involving L3 retransmissions, in some embodiments.

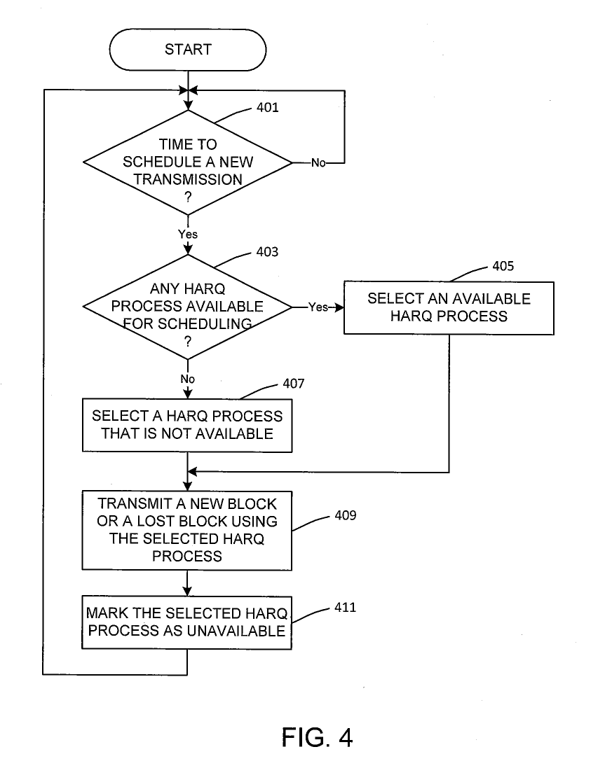

FIG. 4 is a flowchart of an embodiment of scheduling processing according to the present disclosure. The scheduling process waits at decision block 401 for a time to schedule a new transmission to a UE. When it is time to schedule a new transmission to the UE, the scheduling process determines, at decision block 403, if any of the UE's HARQ processes are available for scheduling. A UE HARQ process is considered available for scheduling, if the scheduler knows the result of the previous transmission, i.e. if it resulted in an ACK or in a NACK. If it was a NACK, a retransmission can be scheduled and if it was an ACK, a new block of data can be scheduled for transmission without risking overwriting soft bits of a previous transmission that could be used for soft combining. If, at decision block 403, there is an available HARQ process, the scheduling process selects an available HARQ process, at block 405, and transmits a new block, a lost block or a combination thereof using the selected HARQ process, at block 409. The scheduling process then marks the selected HARQ process as unavailable, if not already so marked, at block 411, and returns to decision block 401 to for a time to schedule a new transmission to a UE.

Referring again to decision block 403, if none of UE's HARQ processes are available for scheduling, the scheduling process selects a HARQ process that is not available, as indicated generally at block 407. In one embodiment, the scheduling process selects an unavailable HARQ process for which the previous block carried L3 traffic that does not require the delivery of each L3 block (e.g. unacknowledged mode traffic in LTE RLC). This may reduce the negative impact of the transmission using an unavailable HARQ process in the case that the reception of the previous was unsuccessful (NACK). In one embodiment, the scheduled new data transmission advantageously avoids any risk of interfering with the decoding of the previous L2 block on the same HARQ process. For example, if the UE has already started to transmit the ACK/NACK, then it is clear that the decoding of the previous L2 block has already been finished. After the scheduling process has selected an unavailable HARQ process, the scheduling process continues to block 409, as described above.

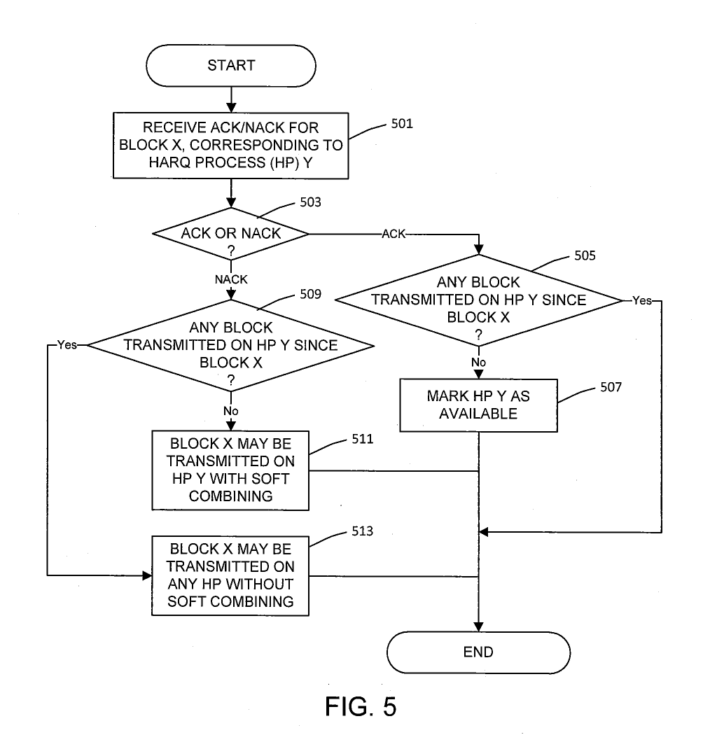

FIG. 5 is a flowchart of an embodiment of response processing according to the present disclosure. The process receives a response (i.e., an ACK or a NACK) for a block X transmitted to a UE corresponding to the UE's HARQ process (HP) Y, which is in an unavailable state, as indicated at block 501. When a response is received, the response process determines, at decision block 503, if the response is an ACK or a NACK. If the response is an ACK, which indicates that block X was successfully received, the response process determines, at decision block 505, if any block since block X was transmitted using HP Y. If it is determined that no block since block X was transmitted using HP Y, the response process marks HP Y as available, at block 507, and processing according to FIG. 5 ends. If it is determined that a block has been transmitted using HP Y since block X, processing ends, with HP Y remaining in the unavailable state.

Referring again to decision block 503, if the response is a NACK, which indicates that block X was not successfully received, the response process determines, at decision block 509, if any block since block X was transmitted using HP Y. If it is determined that no block since block X was transmitted using HP Y, block X may be retransmitted on HP Y, with soft combining, as indicated at block 511, since the soft bits for block X are intact in the UE, and processing ends. If it is determined that a block was transmitted using HP Y since block X, this indicates that block X has been lost since the soft bits for block X in the UE are likely to have been overwritten by the new block. In this case, block X may be retransmitted on any HARQ process without soft combining with the previous transmission of block X on HP Y, as indicated at block 513, and processing according to FIG. 5 ends.

While various embodiments of the invention have been described above, it should be understood that they have been presented by way of example only, and not of limitation. Likewise, the various diagrams may depict an example architectural or other configuration for the invention, which is done to aid in understanding the features and functionality that can be included in the invention. The present invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

One or more of the functions described in this document may be performed by one or more appropriately configured units. The term “unit” as used herein, refers to software that is stored on computer-readable media and executed by one or more processors, firmware, hardware, and any combination of these elements for performing the associated functions described herein. Additionally, for purpose of discussion, the various units may be discrete units; however, as would be apparent to one of ordinary skill in the art, two or more units may be combined to form a single unit that performs the associated functions according embodiments of the invention.

Additionally, one or more of the functions described in this document may be performed by means of computer program code that is stored in a “computer program product,” “computer-readable medium,” and the like, which is used herein to generally refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), which when executed, enable the computing system to perform the desired operations.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate units, processors or controllers may be performed by the same unit, processor or controller. Hence, references to specific functional units are only to be seen as references to suitable means for providing the described functionality, rather than indicative of a strict logical or physical structure or organization.

What is claimed is:

1. A system for transmitting data to user equipment (UE), comprising:
a downlink transmitter configured to transmit a first data unit to the UE using a first transmission process selected from a plurality of transmission processes allocated for the UE;
an uplink receiver configured to receive a status signal indicating either a successful or unsuccessful reception of the first data unit by the UE; and
a downlink scheduler, communicatively coupled to the downlink transmitter and uplink receiver, and configured to receive the status signal from the uplink receiver, wherein the downlink scheduler is further configured to schedule transmission of a second data unit to the UE and transmit a corresponding scheduling decision to the downlink transmitter prior to receiving the status signal, and wherein upon receiving the scheduling decision, the downlink transmitter transmits the second data unit to the UE using a second transmission process selected from the plurality of transmission processes allocated for the UE, wherein the second transmission process is selected to be an unavailable transmission process when no other transmission process is available.

2. The system of claim 1, wherein the first transmission process comprises a first hybrid automatic repeat request (HARQ) process and the second transmission process comprises a second HARQ process that is selected to avoid interfering with decoding of the first data unit when the UE receives the second data unit.

3. The system of claim 1, wherein the second transmission process is selected to be a hybrid automatic repeat request (HARQ) process that was last used to transmit data traffic that does not require each data unit to be successfully delivered to the UE, when no other HARQ processes from the plurality of transmission processes allocated for the UE are available.

4. The system of claim 1, wherein the downlink scheduler is further configured to:
determine, at a time for scheduling a new transmission to the UE, whether any transmission processes are available for transmitting the second data unit;
if a transmission process is available for scheduling, select the available transmission process as the second transmission process;
if no transmission process is available for transmitting the second data unit, select an unavailable transmission process as the second transmission process; and
schedule transmission of the second data unit using the selected second transmission process.

5. The system of claim 1, wherein the downlink scheduler is further configured to:
upon receiving the status signal, determine if the first data unit was successfully received by the UE;
if the first data unit was successfully received, determine if any other data unit was transmitted using the first transmission process since transmission of the first data unit;
if no other data unit was transmitted using the first transmission process since transmission of the first data unit, mark the first transmission process as available;
if another data unit was transmitted using the first transmission process since transmission of the first data unit, maintain a status of the first transmission process as unavailable;
if the first data unit was not successfully received, determine if any other data unit was transmitted using the first transmission process since transmission of the first data unit;
if no other data unit was transmitted using the first transmission process since transmission of the first data unit, retransmit the first data unit using the first transmission process thereby allowing soft combining of the retransmitted first data unit with data bits previously stored in connection with the previous transmission of the first data unit by the UE; and
if another data unit was transmitted using the first transmission process since transmission of the first data unit, retransmit the first data unit using a third transmission process.

6. The system of claim 5, wherein the first and third transmission processes each comprise a hybrid automatic repeat request (HARQ) process last used to transmit open systems interconnect (OSI) media access control (MAC) layer data traffic, and the second transmission process comprises a HARQ process last used to transmit higher layer data traffic that does not require each data unit to be successfully delivered to the UE.

7. The system of claim 1, wherein the downlink transmitter is located in a first communication node and the downlink scheduler is located in a second communication node that is located remotely from the first communication node.

8. The system of claim 7, wherein the uplink receiver is located in a third communication node that is located remotely from the first and second communication nodes.

9. A method for transmitting data to user equipment (UE), comprising:
transmitting a first data unit to the UE using a first transmission process selected from a plurality of transmission processes allocated for the UE;
awaiting receipt of a status signal indicating either a successful or unsuccessful reception of the first data unit by the UE;
prior to receiving the status signal, scheduling transmission of a second data unit to the UE; and
transmitting the second data unit to the UE using a second transmission process selected from the plurality of transmission processes allocated for the UE, wherein the second transmission process is selected to be an unavailable transmission process when no other transmission process is available.

10. The method of claim 9, wherein the first transmission process comprises a first hybrid automatic repeat request (HARQ) process and the second transmission process comprises a second HARQ process that is selected to avoid interfering with decoding of the first data unit when the UE receives the second data unit.

11. The method of claim 9, wherein the second transmission process is selected to be a HARQ process that was last used to transmit data traffic that does not require successful delivery of each data unit, when no other HARQ processes from the plurality of transmission processes allocated for the UE are available.

12. The method of claim 9, further comprising:
determining, at a time for scheduling a new transmission, whether any transmission processes are available for transmitting the second data unit;
if a transmission process is available for scheduling, selecting the available transmission process as the second transmission process;
if no transmission process is available for transmitting the second data unit, selecting an unavailable transmission process as the second transmission process; and
scheduling transmission of the second data unit using the selected second transmission process.

13. The method of claim 9, further comprising:
upon receiving the status signal, determining if the first data unit was successfully received by the UE;
if the first data unit was successfully received, determining if any other data unit was transmitted using the first transmission process since transmission of the first data unit;
if no other data unit was transmitted using the first transmission process since transmission of the first data unit, marking the first transmission process as available;
if another data unit was transmitted using the first transmission process since transmission of the first data unit, maintaining a status of the first transmission process as unavailable;
if the first data unit was not successfully received, determining if any other data unit was transmitted using the first transmission process since transmission of the first data unit;
if no other data unit was transmitted using the first transmission process since transmission of the first data unit, retransmitting the first data unit using the first transmission process, thereby allowing soft combining of the retransmitted first data unit with data bits previously stored in connection with the previous transmission of the first data unit by the UE; and
if another data unit was transmitted using the first transmission process since transmission of the first data unit, retransmitting the first data unit using a third transmission process.

14. The method of claim 13, wherein the first and third transmission processes each comprise a hybrid automatic repeat request (HARQ) process last used for transmitting open systems interconnect (OSI) media access control (MAC) layer data traffic, and the second transmission process comprises a HARQ process last used for transmitting higher layer data traffic that does not require each data unit to be successfully delivered to the UE.

15. The method of claim 9, wherein awaiting receipt of the status signal comprises awaiting receipt of the status signal by an uplink receiver located in a first communication node, and thereafter awaiting receipt of the status signal by a downlink scheduler located in a second communication node that is located remotely from the first communication node.

16. The method of claim 15, wherein scheduling transmission of the second data unit occurs prior to the status signal being received by the downlink scheduler.

17. A computer-readable medium storing computer program code that when executed perform a method for transmitting data to user equipment (UE), the method comprising:
transmitting a first data unit to the UE using a first transmission process selected from a plurality of transmission processes allocated for the UE;
awaiting receipt of a status signal indicating either a successful or unsuccessful reception of the first data unit by the UE;
prior to receiving the status signal, scheduling transmission of a second data unit to the UE; and
transmitting the second data unit to the UE using a second transmission process selected from the plurality of transmission processes allocated for the UE, wherein the second transmission process is selected to be an unavailable transmission process when no other transmission process is available.

18. The computer-readable medium of claim 17, wherein the method further comprises:
determining, at a time for scheduling a new transmission, whether any transmission processes are available for transmitting the second data unit;
if a transmission process is available for scheduling, selecting the available transmission process as the second transmission process;
if no transmission process is available for transmitting the second data unit, selecting an unavailable transmission process as the second transmission process; and
scheduling transmission of the second data unit using the selected second transmission process.

19. The computer-readable medium of claim 17, wherein the method further comprises:
upon receiving the status signal, determining if the first data unit was successfully received by the UE;
if the first data unit was successfully received, determining if any other data unit was transmitted using the first transmission process since transmission of the first data unit;
if no other data unit was transmitted using the first transmission process since transmission of the first data unit, marking the first transmission process as available;
if another data unit was transmitted using the first transmission process since transmission of the first data unit, maintaining a status of the first transmission process as unavailable;
if the first data unit was not successfully received, determining if any other data unit was transmitted using the first transmission process since transmission of the first data unit;
if no other data unit was transmitted using the first transmission process since transmission of the first data unit, retransmitting the first data unit using the first transmission process, thereby allowing soft combining of the retransmitted first data unit with data bits previously stored in connection with the previous transmission of the first data unit by the UE; and
if another data unit was transmitted using the first transmission process since transmission since transmission of the first data unit, retransmitting the first data unit using a third transmission process.

20. The computer-readable medium of claim 19, wherein the first and third transmission processes each comprise a hybrid automatic repeat request (HARQ) process last used for transmitting open systems interconnect (OSI) media access control (MAC) layer data traffic, and the second transmission process comprises a HARQ process last used for transmitting higher layer data traffic that does not require each data unit to be successfully delivered to the UE.
